(19) United States
(12) Patent Application Publication
(10) Pub. No.: US 2021/0102636 A1
(43) Pub. Date: Apr. 8, 2021

(54) VALVE DEVICE

(71) Applicant: FUJIKIN INCORPORATED, Osaka (JP)

(72) Inventors: Toshiyuki SAKAMOTO, Osaka (JP); Hidehiro DOYA, Osaka (JP)

(73) Assignee: FUJIKIN INCORPORATED, Osaka (JP)

(21) Appl. No.: 16/498,706

(22) PCT Filed: Mar. 14, 2018
(86) PCT No.: PCT/JP2018/009871

§ 371 Date: Sep. 27, 2019

(30) Foreign Application Priority Data
Mar. 30, 2017 (JP) 2017-067398

(51) Int. Cl. F16K 31/06; F16K 31/122

(52) U.S. Cl. CPC F16K 31/0658; H01F 7/064; F16K 31/1221

(57) ABSTRACT

A valve device is provided that is a gas-driven type, is capable of mounting various electronic devices, and solves problems involving wiring or battery replacement. The problem is solved by a valve device including a piston member that drives a diaphragm, an actuator part that receives supply of high-pressure air and drives the piston member, a coil spring that presses the piston member in a direction reverse to a driving direction of the actuator part, and a power generation unit provided in a power generation unit-housing part serving as a supply path of high-pressure air to the actuator part and including a screw rotated by air flow and a commutator generator coupled with the screw. The power generation unit generates power using the high-pressure air supplied to the actuator part and a portion of energy stored in the coil spring.

### FIELD OF THE INVENTION

The present invention relates to a valve device that is a gas-driven type.

### DESCRIPTION OF THE BACKGROUND ART

In the field of valve devices as well, an electronic device such as a pressure sensor or a wireless communication module is mounted to increase the functionality of the device (refer to Patent Document 1, for example).

### PATENT DOCUMENTS

Patent Document 1: JP 2017-020530 A

### SUMMARY OF THE INVENTION

### Problems to be Solved by the Invention

Nevertheless, in a valve device that is an air-driven type and uses air pressure, a power source for operating the various electronic devices needs to be secured. Wiring for the power source needs to be introduced into the valve device from the outside. While problems involving wiring are solved when a battery is used as the power source, the task of battery replacement is required.

An object of the present invention is to provide a valve device that is a gas-driven type, is capable of mounting various electronic devices, and solves problems involving wiring or battery replacement.

### Means for Solving the Problems

A valve device according to the present invention is a valve device that opens and closes by a driver gas, and comprises:
a driving member that drives a valve element.
an actuator that receives supply of the driver gas and drives the driving member,
a spring member that presses the driving member in a direction reverse to a driving direction of the actuator, and
a power generation unit provided to a supply path of the driver gas to the actuator, and including a screw rotatable by a gas flow and a generator coupled with the screw.

The power generation unit generates a power by using the driver gas supplied to the actuator and using a portion of energy stored in the spring member.

Preferably, a configuration can be adopted in which the power generation unit generates a power by rotation of the screw by a driver gas flowing through the supply path when the driver gas supplied to the actuator is discharged to the outside.

More preferably, a configuration can be adopted in which the power generation unit idles the screw to suppress pressure loss in the supplied gas when the driver gas is supplied to the actuator. In this case, a configuration can be adopted in which the valve device further includes a circuit for extracting only a power generated by rotation of the screw by the driver gas flowing through the supply path when the driver gas supplied to the actuator is released to the outside of the actuator.

More preferably, a configuration can also be adopted in which the valve device further includes a power supply circuit that boosts a voltage generated by the generator, a load activated by power supplied from the power supply circuit, and a secondary battery or a capacitor that receives a power supplied from the power supply circuit.

### Effect of the Invention

According to the present invention, power is generated using a driver gas, that has been supplied to an actuator and that is otherwise discharged to the outside, and using a portion of energy stored in a spring member, making it possible to obtain a valve device in which a power generation unit is capable of generating power without hindering operation of the actuator and without supply of additional energy.

### BRIEF DESCRIPTION OF THE DRAWINGS

FIG. 1A is an external perspective view of a valve device according to an embodiment of the present invention.

FIG. 1B is a longitudinal sectional view of the valve device in FIG. 1A, in a valve opened state.

FIG. 1C is a longitudinal sectional view of the valve device in FIG. 1A, in a valve closed state.

FIG. 2A is a perspective view including a partial longitudinal section, of a power generation unit-housing part and a power generation unit.

FIG. 2B is a longitudinal sectional view of FIG. 2A.

FIG. 2C is a top view of the power generation unit-housing part of FIG. 2A.

FIG. 3A is a schematic configuration diagram of an example of a valve system that activates the valve device in FIG. 1A.

FIG. 3B is a diagram for explaining a flow of energy during actuator-driving (when the valve is opened) in the system in FIG. 3A.

FIG. 3C is a diagram for explaining a flow of energy during pressure release (when the valve is closed) in the system in FIG. 3A.

FIG. 4 is a functional block diagram schematically illustrating an example of a load circuit.

### DESCRIPTION OF THE PREFERRED EMBODIMENTS

Embodiments of the present invention are described below with reference to the drawings. It should be noted that, in this specification and the drawings, components having substantially the same function are denoted using the same reference numerals, and duplicate descriptions thereof are omitted.

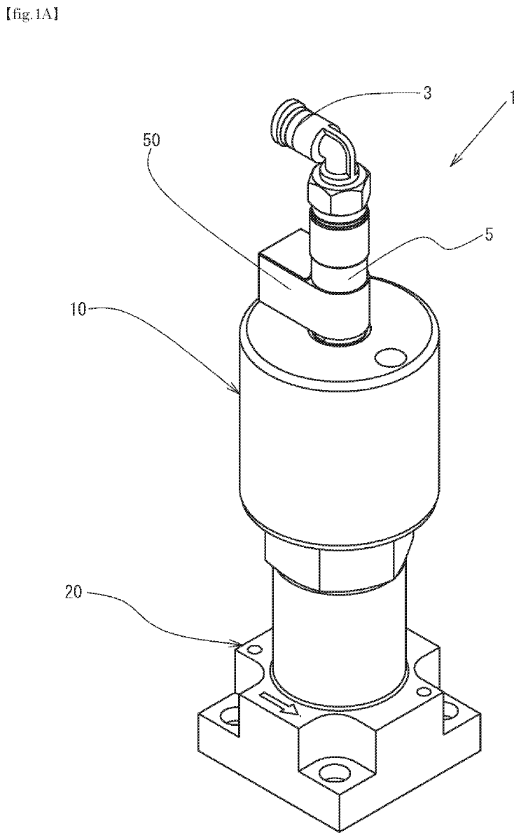

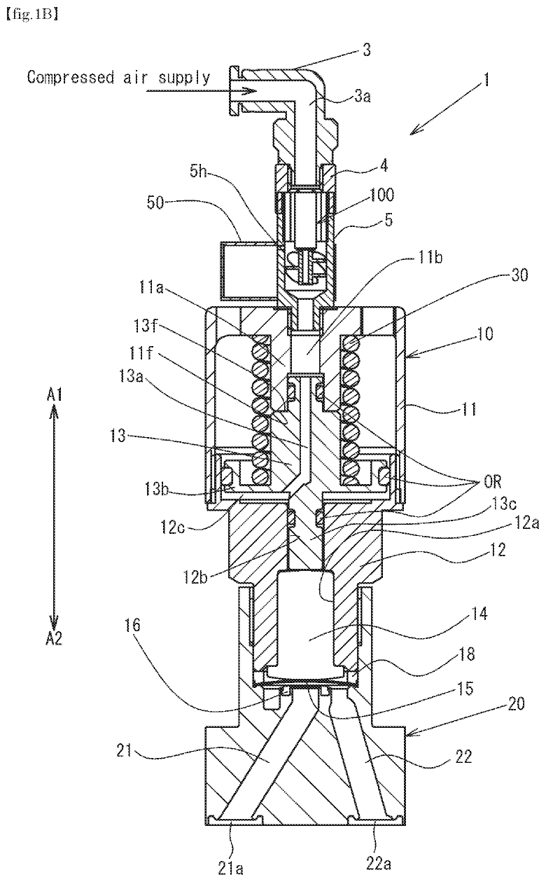

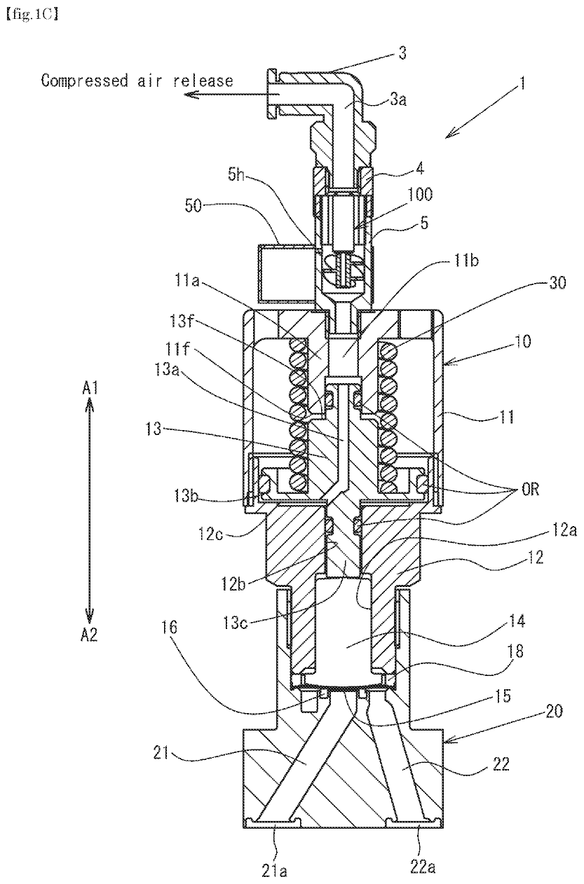

FIGS. 1A to 1C are drawings illustrating a configuration of a valve device according to an embodiment of the present invention. FIG. 1A is an external perspective view, FIG. 1B is a longitudinal sectional view in an opened state, and FIG. 1C is a longitudinal sectional view in a closed state. It should be noted that, in FIGS. 1B and 1C, arrows A1, A2 indicate upward and downward directions, A1 being the upward direction and A2 being the downward direction.

A valve device 1 includes a pipe joint 3, a power generation unit-housing part 5, an actuator part 10, a valve body 20, and a circuit housing part 50. The pipe joint 3 includes a flow channel 3a for air, connects to piping (not illustrated), and supplies compressed air as a driver gas to the actuator part 10 through the flow channel 3a, or discharges air released from the actuator part to the outside through the flow channel 3a.

The power generation unit-housing part 5 is formed using a cylindrical member, and is connected with the pipe joint 3 by a connecting member 4 having a cylindrical shape. The power generation unit-housing part 5 houses a power generation unit 100 and serves as an air flow channel as well.

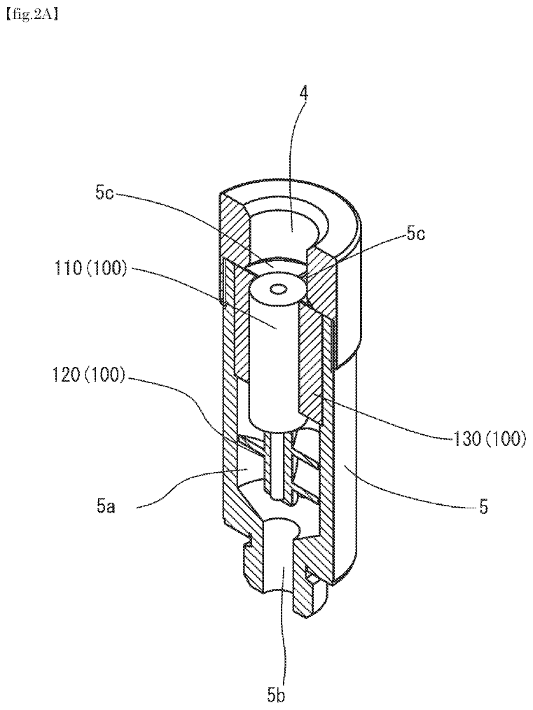

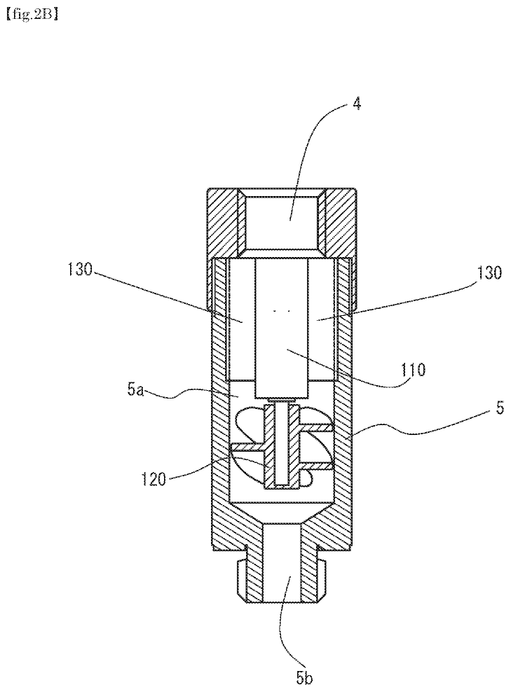

FIGS. 2A to 2C illustrate an internal structure of the power generation unit-housing part 5.

The power generation unit 100 includes a commutator generator 110, a screw 120 fixed to a rotating shaft of the commutator generator 110, and four support plates 130 for fixing a casing of the commutator generator 110 to an inner cavity 5a of the power generation unit-housing part 5. The inner cavity 5a serves as an air flow channel as well.

The four support plates 130 are fixed to the periphery of the commutator generator 110 at equal intervals, and are held between the connecting member 4 and the power generation unit-housing part 5. Further, the four support plates 130 define four flow channels 5c through which air flows. Accordingly, air can flow between the connecting member 4 and a flow channel 5b of the power generation unit-housing part 5.

The screw 120 rotates in one direction by the flow of air from the connecting member 4 side toward the power generation unit-housing part 5, and rotates in a direction reverse to that described above by the flow of air from the flow channel 5b toward the connecting member 4 side. While rotation of the screw 120 is transmitted to the commutator generator 110, power is generated in a state where the commutator generator 110 is electrically connected to a load circuit, and not generated in a state where the commutator generator 110 is not electrically connected with a load circuit, causing idling of the screw 120, as described later.

The circuit housing part 50 houses a diode D1, a power supply integrated circuit (IC) 601, a microcomputer 603, a wireless communication part 605, a secondary battery 602, and the like described later. Further, electrical wiring and the like of the power generation unit 100 are guided to the circuit housing part 50 through an communicating hole 5h formed in the power generation unit-housing part 5.

The actuator part 10 includes an actuator cap 11 having a cylindrical shape, an actuator body 12, a piston member 13, and a diaphragm presser 14 as an operating member.

The actuator cap 11 is connected with a lower end part of the power generation unit-housing part 5 described above at a central portion of a ceiling part, and includes a cylindrical part 11a extending from this ceiling part in the downward direction A2. An inner peripheral surface of the cylindrical part 11a defines a flow channel 11b for air, and the flow channel 11b communicates with the flow channel 5b of the power generation unit-housing part 5.

The actuator body 12 includes a guide hole 12a that guides the diaphragm presser 14 in the upward and downward directions A1, A2 at a lower side thereof, and communicates to an upper side of the guide hole 12a to form a through hole 12b. On an upper side of the actuator body 12, a cylinder chamber 12c is formed, which slidably guides a piston part 13b of the piston member 13 in the upward and downward directions A1, A2 via an O-ring OR.

The piston member 13 includes a flow channel 13a communicating to the cylinder chamber 12c in a central portion. The flow channel 13a communicates with the flow channel 3a of the pipe joint 3. The piston part 13b and a tip end shaft pan 13c of the piston member 13 freely moves through the cylinder chamber 12c and the through hole 12b in the upward and downward directions A1, A2 via the O-ring OR.

The diaphragm presser 14 freely moves in the upward and downward directions A1, A2 by the guide hole 12a of the actuator body 12.

The valve body 20 has an upper side connected with a lower side of the actuator body 12, and defines flow paths 21, 22 of a gas or the like that include openings 21a, 22a on bottom surfaces thereof. The flow paths 21, 22 are connected with other flow path members via a seal member (not illustrated).

A valve seat 16 is provided around the flow path 21 of the valve body 20. The valve seat 16 is formed of a resin such as perfluoroalkoxy alkane (PFA) or a polytetrafluoroethylene (PTFE) in an elastically deformable manner.

A diaphragm 15 functions as a valve element, has a larger diameter than the valve seat 16, and is formed in an elastically deformable manner into a spherical shell shape by a metal such as stainless steel or an NiCo-based alloy, or a fluorine-based resin. The diaphragm 15 is supported by the valve body 20 so as to allow contact with and separation from the valve seat 16 by being pressed toward the valve body 20 by a lower end surface of the actuator body 12 via a pressing adapter 18. In FIG. 1C, the diaphragm 15 is in a state of being pressed by the diaphragm presser 14, elastically deformed, and pressed against the valve seat 16. When the pressing by the diaphragm presser 14 is released, the diaphragm 15 is restored into a spherical shell shape. When the diaphragm 15 is pressed against the valve seat 16, the flow path 21 is closed, and when the diaphragm 15 is separated from the valve seat 16 as illustrated in FIG. 1B, the flow path 21 is released and communicates with the flow path 22.

A coil spring 30 is interposed between the ceiling part of the actuator cap 11 and the piston part 13b of the piston member 13, and the piston member 13 is continually pressed by a restoring force in the downward direction A2. Accordingly, an upper end surface of the diaphragm presser 14 is pressed in the downward direction A2 by the piston member 13, and the diaphragm 15 is pressed toward the valve seat 16.

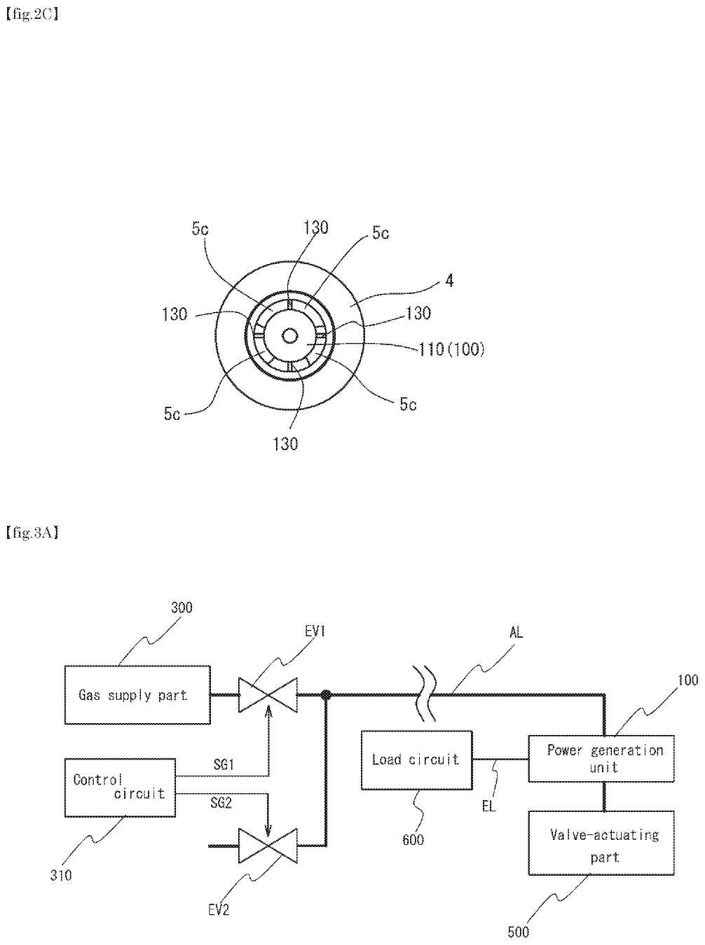

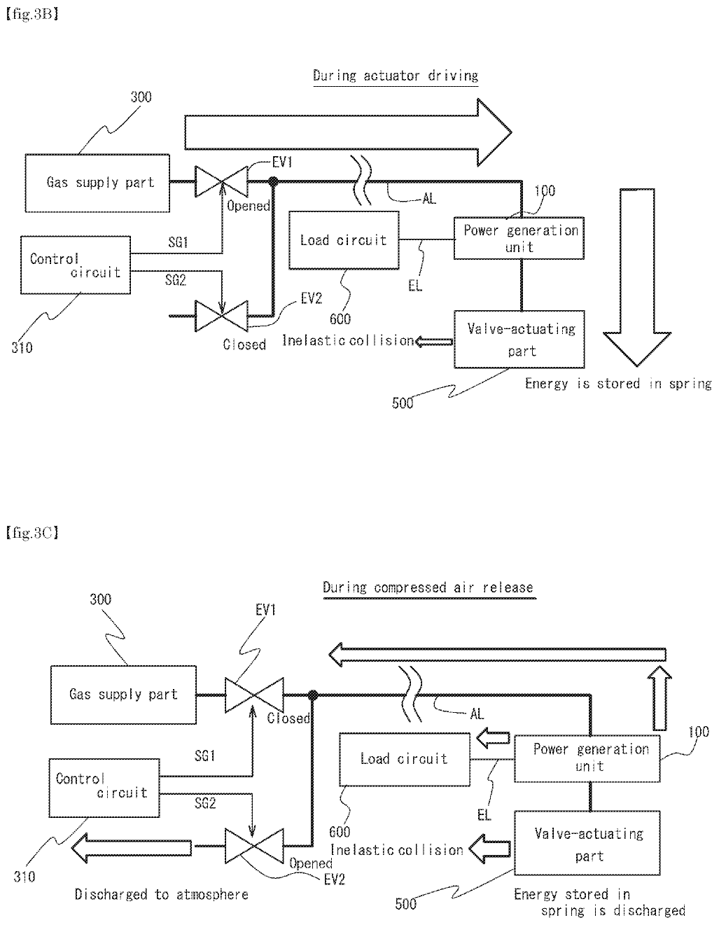

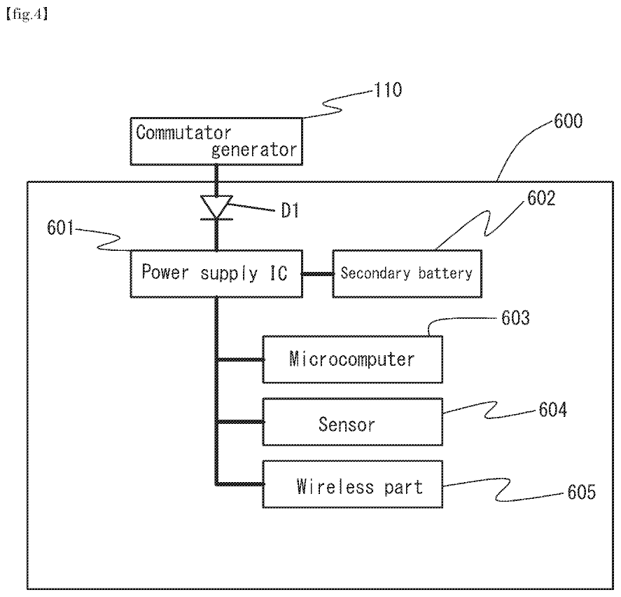

FIG. 3A illustrates an example of a system that activates the valve device 1 having the above-described configuration. In FIG. 3A, a valve-activating part 500 is a portion related to a flow of energy when the valve device 1 is activated, and refers to the actuator part 10 and the coil spring 30. A gas supply source 300 has a function of supplying a driver gas to the valve device 1 through an air line AL fluidly connected to the pipe joint 3 of the valve device 1, and is, for example, an accumulator or a gas cylinder. An electromagnetic valve EV1 is provided in the middle of the air line AL, and an electromagnetic valve EV2 is provided to the air line AL branched on a downstream side of the electromagnetic valve EV1. A control circuit 310 outputs control signals SG1, SG2 to the electromagnetic valves EV1, EV2 to control the opening and closing of the electromagnetic valves EV1, EV2.

A load circuit 600 is an electric circuit electrically connected to the commutator generator 110 of the power generation unit 100 as a load. The load circuit 600 is electrically connected to the power generation unit 100 via an electrical line EL.

FIG. 4 illustrates an example of the load circuit 600. It should be noted that, in the drawings, a GND line is omitted.

The load circuit 600 includes the diode D1, the power supply IC 601, the secondary battery 602, the microcomputer 603, various sensors 604 such as a pressure sensor and a temperature sensor, and the wireless communication part 605 capable of transmitting data detected by the various sensors 604 to the outside.

The diode D1 of the load circuit 600 plays the role of electrically connecting the load circuit 600 to the commutator generator 110 only when a portion of the energy stored in the coil spring 30 is used to generate power. The power generation unit 100 is capable of generating power even when the screw 120 is rotated in either the forward or reverse direction and, while both positive and negative direct current power can be generated, the diode D1 is provided to consume generated power only when the driver gas supplied to the valve device 1 is released (in the forward direction).

The power supply IC 601 functions as a power management IC that regulates power transmitted to a power supply destination such as the microcomputer 603, the various sensors 604, or the wireless communication part 605, while boosting and storing the power from the commutator generator 110 in the secondary battery 602. For example, a power supply IC commonly available for energy harvesting can be adopted.

The secondary battery 602 stores direct current power supplied from the power supply IC 601. A capacitor having a relatively large capacity can also be used in place of the secondary battery.

Components other than the various sensors 604 are housed in the circuit housing part 50 described above, and the various sensors 604 are disposed near the flow path or the like of the valve device 1 to detect pressure and temperature, and are electrically connected by wiring with the power supply IC 601 and the microcomputer 603.

Next, the schematic flow of the energy and the power generation operation of the power generation unit 100 of the system in FIG. 3A will be described with reference to FIGS. 3B and 3C.

When the valve is opened, the actuator part 10 needs to be driven and thus, as illustrated in FIG. 3B, the electromagnetic valve EV1 is opened and the electromagnetic valve EV2 is closed. Accordingly, the driver gas is supplied from the gas supply source 300 to the valve device 1. The driver gas is compressed air, for example, and has a pressure high enough to drive the valve device 1.

At this time, the screw 120 is rotated in the negative direction by the driver gas passing through the power generation unit 100. Thus, in the load circuit 600, power is not consumed. Because power is not consumed in the load circuit 600, a load is not applied to the screw 120 and the screw idles. As a result, the piston member 13 can be activated as desired without substantial pressure loss of the supplied driver gas.

The piston member 13 is pressed in the upward direction A1 by the supply of the driver gas to the valve device 1 as illustrated in FIG. 1B, and the coil spring 30 is compressed to store energy in the coil spring 30. At this time, as illustrated in FIG. 1B, a contact surface 13f of the piston member 13 inelastically collides with a contact surface 11f of the actuator cap 11, and thus a portion of the energy supplied from the gas supply source 300 to the valve device 1 is converted to heat and vibration and discharged.

When the valve is closed, the driver gas stored in the valve device 1 is released, and the energy stored in the coil spring 30 is discharged. As illustrated in FIG. 3C, the electromagnetic valve EV1 is closed and the electromagnetic valve EV2 is opened. When the driver gas is discharged from the valve device 1 to the outside through the air line AL and the electromagnetic valve EV2, the driver gas drives the screw 120 of the power generation unit 100 in the forward direction, thereby supplying power to the load circuit 600. The supplied power is used to charge the secondary battery 602 while consumed by the various sensors 604 and the like.

Because the secondary battery 602 is charged while the valve is used, long-term operation is possible using the secondary battery 602 having a small capacity compared to when a primary battery is used. The energy stored in the battery can be reduced, making it possible to suppress damage to surroundings to a minimum even when a fault caused by the battery temporarily occurs.

According to the present embodiment, when the driver gas stored in the valve device 1 is released to close the valve device 1, the energy stored in the valve device 1, that is, the driver gas and a portion of the energy stored in the coil spring 30 is utilized to generate power, making it possible to obtain a valve device 1 in which the power generation unit 100 is capable of generating power without hindering operation of the actuator part 10 and without supply of additional energy. Accordingly, it is possible to maintain a valve response speed while keeping the supplied air pressure as is. Further, in the valve device 1 according to the present embodiment, power is generated utilizing a portion of the energy that is otherwise consumed by discharge to the outside through the electromagnetic valve EV2, inelastic collision resulting from the diaphragm presser 14 colliding with the valve seat 16 via the diaphragm 15, and the like, and thus the valve device 1 contributes to alleviation of the impact of the inelastic collision as well. As a result, the remarkable effect of suppressing the occurrence of cracking of the diaphragm 15 and extending the service life of the valve device 1 is obtained.

While a so-called normally closed valve is given as an example in the above-described embodiment, the present invention is not necessarily limited thereto and can be applied to a so-called normally opened valve as well.

While a case where the valve device 1 is driven by compressed air is given as an example in the above-described embodiment, a gas other than air can also be used.

While a diaphragm-type valve is given as an example in the above-described embodiment, the present invention is not necessarily limited thereto and can be applied to other types of valves as well.

### DESCRIPTIONS OF REFERENCE NUMERALS

1 Valve device
3 Pipe joint
5 Power generation unit-housing part
10 Actuator part (Actuator)
11 Actuator cap
12 Actuator body
13 Piston member (Driving member)
14 Diaphragm presser
15 Diaphragm
16 Valve seat
18 Pressing adapter
20 Valve body
30 Coil spring (Spring member)
50 Circuit-housing part
100 Power generation unit
110 Commutator generator
120 Screw
130 Support plate
300 Gas supply source
310 Control circuit
500 Valve-actuating part
600 Load circuit

What is claimed is:

1. A valve device comprising:
a driving member that drives a valve element;
an actuator that receives supply of a driver gas and drives the driving member; and
a power generation unit provided to a supply path of the driver gas to the actuator, and including a screw rotatable by a gas flow and a generator coupled with the screw.

2. The valve device according to claim 1, further comprising:
a spring member that presses the driving member in a direction reverse to a driving direction of the actuator, wherein
the power generation unit generates a power by using the driver gas supplied to the actuator and using a portion of energy stored in the spring member.

3. The valve device according to claim 2, wherein
the power generation unit generates the power by rotation of the screw by the driver gas flowing through the supply path when the driver gas supplied to the actuator is discharged to the outside.

4. The valve device according to claim 3, wherein
the power generation unit idles the screw when the driver gas is supplied to the actuator.

5. The valve device according to claim 4 further comprising:
a circuit for extracting only a current in a direction generated by rotation of the screw by the driver gas flowing through the supply path when the driver gas supplied to the actuator is released outside the actuator.

6. The valve device according to claim 5, further comprising:
a power supply circuit that boosts a voltage of power generated by the generator; and
a load activated by power supplied from the power supply circuit.

7. The valve device according to claim 6, further comprising:
a secondary battery or a capacitor that receives a power supplied from the power supply circuit.
